(19) United States
(12) Patent Application Publication
(10) Pub. No.: US 2007/0193249 A1
(43) Pub. Date: Aug. 23, 2007

(54) Air pressure control device in integrated gasification combined cycle system

(75) Inventors: Yasuhiro Takashima, Takasago-shi (JP); Satoko Fujii, Takasago-shi (JP)

Correspondence Address: BIRCH STEWART KOLASCH & BIRCH, PO BOX 747, FALLS CHURCH, VA, 22040-0747, US

(73) Assignee: Mitsubishi Heavy Industries, Ltd., Tokyo (JP)

(21) Appl. No.: 11/699,371

(22) Filed: Jan. 30, 2007

(30) Foreign Application Priority Data
Feb. 10, 2006 (JP) 2006-033204

(51) Int. Cl. F02C 6/00

(52) U.S. Cl. 60/39.181

(57) ABSTRACT

Air bled from an air compressor of a gas turbine is taken into a booster via an inlet guide vane. Air compressed by the booster is supplied to a gasifier via an air supply valve. An air pressure controller controls the opening of the inlet guide vane by feedback control and, when a gasifier load command changes, priorly controls the opening of the inlet guide vane immediately in response to this change.

### BACKGROUND OF THE INVENTION

1. Field of the Invention

This invention relates to an air pressure control device in an integrated gasification combined cycle system, which is designed to stabilize the pressure of air supplied from a booster to a gasifier even in an unsteady state where the load on the gasifier has varied.

2. Description of the Related Art

An integrated coal gasification combined cycle (IGCC) system is present as a power generation technology which is excellent in power efficiency and environmental friendliness in comparison with the existing pulverized coal-fired power generation.

The outline of the integrated coal gasification combined cycle system will be described by reference to FIG. 4. As shown in FIG. 4, a gasifier 1 is supplied with air a via an air supply valve 2, and is also supplied with coal (pulverized coal) b by a feeder 3. The gasifier 1 burns the coal b with the air a, which is an oxidizing agent, to form a coal gas c.

The resulting coal gas c is subjected to purification treatments, such as cooling, dedusting and desulfurization, in gas purification equipment 4 to become a fuel gas d. The fuel gas d is supplied to a combustor 5-1 of a gas turbine 5. In the combustor 5-1, air compressed by an air compressor 5-2 and the fuel gas d are burned to form a high temperature, high pressure combustion gas. This combustion gas is supplied to a turbine 5-3 to drive the turbine 5-3 rotationally.

Air a bled from the air compressor 5-2 is increased in pressure by a booster 6, and then supplied to the gasifier 1. The booster 6 is equipped with an inlet guide vane 6-1. The booster 6 is also provided with recirculation piping 6-2 for sending air, as a feedback, from the outlet of the booster to the inlet of the booster, and a recirculation valve 6-3 is interposed in the recirculation piping 6-2.

The booster 6 takes in air, which has been bled from the air compressor 5-2, via the inlet guide vane 6-1, and ejects the taken-in air after compressing it. The compressed air ejected from the booster 6 is supplied to the gasifier 1 via an air path where the air supply valve 2 is interposed. The opening of the air supply valve 2 is controlled in accordance with the load on the gasifier 1, as will be described later.

On the other hand, an exhaust gas e discharged from the turbine 5-3 of the gas turbine 5 is subjected to heat recovery by a waste heat boiler 7, and the waste heat boiler 7 generates steam f. This steam f is supplied to a steam turbine 8 to rotate the steam turbine 8.

The rotation of the turbine 5-3 of the gas turbine 5 and the rotation of the steam turbine 8 result in the rotation of a generator (not shown) to perform power generation.

Next, a description will be offered of a conventional air pressure control device in the integrated gasification combined cycle system having the above-described configuration.

It has been conventional practice to detect the pressure of the air a ejected from the outlet of the booster 6 and supplied to the gasifier 1. The opening of the inlet guide vane 6-1 has been adjusted such that the detected pressure will have a preset constant value.

Alternatively, the opening of the inlet guide vane 6-1 has been adjusted such that the detected pressure of the air a will become a set pressure (set value) in conformity with a gasifier load. The term “gasifier load” refers to a load in conformity with a requirement for fuel to be charged into the gasifier 1.

That is, the opening of the inlet guide vane 6-1 has been feedback-controlled such that the pressure of the air a ejected from the outlet of the booster 6 takes the constant value or the set value.

In other words, feedback control has been exercised in the following manner: If the pressure of the air a on the outlet side of the booster 6 changes from the constant value (or the set value), this change is detected, and the opening of the inlet guide vane 6-1 is adjusted to adjust the amount of air taken into the booster 6 from the inlet side so that the air pressure on the outlet side returns to the constant value (or the set value).

When the flow rate of the air a is a low flow rate, the valve opening of the recirculation valve 6-3 is controlled to adjust the amount of recirculating air returning from the outlet to the inlet of the booster 6 in order to prevent a surge in the booster 6.

As documents on the related art, Japanese Unexamined Patent Publication No. 1997-96227 and Japanese Unexamined Patent Publication No. 1994-288262 are named.

If the load on the gasifier 1 (gasifier load) changes, the opening of the air supply valve 2 and the amount of the coal b supplied by the feeder 3 are adjusted in accordance with this change.

If the gasifier load increases, for example, the feeder 3 is controlled to increase the amount of the coal b supplied from the feeder 3 to the gasifier 1. At the same time, the opening of the air supply valve 2 is controlled to increase the amount of air supplied to the gasifier 1.

If the gasifier load decreases, on the other hand, the feeder 3 is controlled to decrease the amount of the coal b supplied from the feeder 3 to the gasifier 1. At the same time, the opening of the air supply valve 2 is controlled to decrease the amount of air supplied to the gasifier 1.

When the gasifier load increases, leading to an increase in the opening of the air supply valve 2 and an increase in the amount of the air a supplied to the gasifier 1, the air pressure on the outlet side of the booster 6 lowers. With the conventional control method, it has been common practice to exercise feedback control so as to open the inlet guide vane 6-1 after detection of this decline in the air pressure, thereby returning the air pressure on the outlet side of the booster 6 to the constant value (or the set value).

When the gasifier load decreases, leading to a decrease in the opening of the air supply valve 2 and a decrease in the amount of the air a supplied to the gasifier 1, the air pressure on the outlet side of the booster 6 rises. With the conventional control method, it has been common practice to exercise feedback control so as to constrict the inlet guide vane 6-1 after detection of this rise in the air pressure, thereby returning the air pressure on the outlet side of the booster 6 to the constant value (or the set value).

Conventionally, as described above, when the gasifier load has changed, feedback control over the inlet guide vane 6-1 has been performed after the air pressure on the outlet side of the booster 6 actually changes as a result of the change in the gasifier load. Consequently, follow-up control over the air pressure on the outlet side of the booster 6 has delayed in response to the change in the gasifier load.

As a result, during an unsteady state where the gasifier load has changed, there have been cases where the amount of air actually supplied to the gasifier 1 (amount of air supply) becomes excessively small (when the gasifier load has increased) or excessively large (when the gasifier load has decreased) relative to the amount of air required by the gasifier 1 (air requirement) in accordance with the change. Thus, there has been a possibility for the temporary lack (or excess) of the amount of air supply to the gasifier 1, rendering air supply unstable.

The present invention has been accomplished in light of the above-described problems with the conventional technology. An object of the present invention is to provide an air pressure control device in an integrated gasification combined cycle system which can supply air to a gasifier at a stable pressure even in an unsteady state where the load on the gasifier has changed.

### SUMMARY OF THE INVENTION

A first aspect of the present invention is an air pressure control device in an integrated gasification combined cycle system, the integrated gasification combined cycle system including

a gasifier for forming a coal gas when supplied with coal and air,

a gas turbine driven by burning a fuel gas purified from the coal gas formed by the gasifier,

a booster for taking in air, which has been bled from an air compressor of the gas turbine, via an inlet guide vane, compresses the air taken in, and ejects the air, and

an air supply valve interposed in an air supply path for supplying the gasifier with the air ejected from the booster, the air supply valve being a valve having an opening adjusted to provide a flow rate conformed to a load requirement of the gasifier,

the air pressure control device comprising:

an inlet temperature gauge for detecting a temperature of air on an inlet side of the booster;

an inlet pressure gauge for detecting a pressure of the air on the inlet side of the booster; and

an air pressure controller for adjusting an opening of the inlet guide vane,

the air pressure controller including

air volumetric flow rate computing means for determining an air volumetric flow rate, necessary to satisfy the load requirement of the gasifier, based on a gasifier load command showing the load requirement, an inlet temperature detected by the inlet temperature gauge, and an inlet pressure detected by the inlet pressure gauge,

pressure ratio computing means for determining a set pressure of air, necessary to satisfy the load requirement, based on the gasifier load command, and determining a booster pressure ratio based on the set pressure and the inlet pressure, and

a prior opening command computing section in which a function for setting an opening of the inlet guide vane satisfying the air volumetric flow rate and the booster pressure ratio by using the air volumetric flow rate and the booster pressure ratio as parameters is preset, and which, upon receipt of input of the air volumetric flow rate and the booster pressure ratio, refers to the function, and outputs a prior opening command showing the opening of the inlet guide vane, and

the air pressure controller controlling the opening of the inlet guide vane to become the opening shown by the prior opening command.

A second aspect of the present invention is an air pressure control device in an integrated gasification combined cycle system, the integrated gasification combined cycle system including

a gasifier for forming a coal gas when supplied with coal and air,

a gas turbine driven by burning a fuel gas purified from the coal gas formed by the gasifier,

a booster for taking in air, which has been bled from an air compressor of the gas turbine, via an inlet guide vane, compresses the air taken in, and ejects the air, and

an air supply valve interposed in an air supply path for supplying the gasifier with the air ejected from the booster, the air supply valve being a valve having an opening adjusted to provide a flow rate conformed to a load requirement of the gasifier,

the air pressure control device comprising:

an inlet temperature gauge for detecting a temperature of air on an inlet side of the booster;

an inlet pressure gauge for detecting a pressure of the air on the inlet side of the booster; and

an air pressure controller for adjusting an opening of the inlet guide vane,

the air pressure controller including

an air mass flow rate computing section for determining an air mass flow rate, necessary to satisfy the load requirement of the gasifier, based on a gasifier load command showing the load requirement,

an inlet air density computing section for detecting an inlet air density from an inlet temperature detected by the inlet temperature gauge, and an inlet pressure detected by the inlet pressure gauge,

a first division section for computing an air volumetric flow rate by dividing the air mass flow rate by the inlet air density,

a set pressure computing section for determining a set pressure of air, necessary to satisfy the load requirement, based on the gasifier load command,

a second division section for computing a booster pressure ratio by dividing the set pressure by the inlet pressure, and

a prior opening command computing section in which a function for setting an opening of the inlet guide vane satisfying the air volumetric flow rate and the booster pressure ratio by using the air volumetric flow rate and the booster pressure ratio as parameters is preset, and which, upon receipt of input of the air volumetric flow rate and the booster pressure ratio, refers to the function, and outputs a prior opening command showing the opening of the inlet guide vane, and

the air pressure controller controlling the opening of the inlet guide vane to become the opening shown by the prior opening command.

A third aspect of the present invention is the air pressure control device in an integrated gasification combined cycle system according to the first or second aspect, which further comprises an outlet pressure gauge for detecting a pressure of the air on an outlet side of the booster, and wherein the air pressure controller includes feedback opening command computing means for computing a feedback opening command which reduces deviation between an outlet pressure detected by the outlet pressure gauge and the set pressure to zero, and the air pressure controller controls the opening of the inlet guide vane to become an opening shown by a command which is a sum of the prior opening command and the feedback opening command.

A fourth aspect of the present invention is an air pressure control device in an integrated gasification combined cycle system, the integrated gasification combined cycle system including

a gasifier for forming a coal gas when supplied with coal and air,

a gas turbine driven by burning a fuel gas purified from the coal gas formed by the gasifier,

a booster for taking in air, which has been bled from an air compressor of the gas turbine, via an inlet guide vane, compresses the air taken in, and ejects the air, and

an air supply valve interposed in an air supply path for supplying the gasifier with the air ejected from the booster, the air supply valve being a valve having an opening adjusted to provide a flow rate conformed to a load requirement of the gasifier,

the air pressure control device comprising:

an air pressure controller for adjusting an opening of the inlet guide vane,

the air pressure controller including

a prior opening command computing section in which a function showing a relation between a gasifier load command showing the load requirement of the gasifier and an opening of the inlet guide vane necessary to satisfy the load requirement is preset, and which, upon receipt of input of the gasifier load command, refers to the function, and outputs a prior opening command showing the opening of the inlet guide vane, and

the air pressure controller controlling the opening of the inlet guide vane to become the opening shown by the prior opening command.

A fifth aspect of the present invention is the air pressure control device in an integrated gasification combined cycle system according to the fourth aspect, which further comprises an inlet pressure gauge for detecting a pressure of the air on an inlet side of the booster, and an outlet pressure gauge for detecting a pressure of the air on an outlet side of the booster, and wherein the air pressure controller includes feedback opening command computing means for computing a feedback opening command which reduces deviation between an outlet pressure detected by the outlet pressure gauge and an inlet pressure detected by the inlet pressure gauge to zero, and the air pressure controller controls the opening of the inlet guide vane to become an opening shown by a command which is a sum of the prior opening command and the feedback opening command.

The present invention can also be applied in a case where the gas turbine is operated using a kerosene fuel during a starting process.

According to the present invention, there is computed the prior opening command whose value changes immediately in response to the value of a change, if any, occurring in the gasifier load command. Based on this prior opening command, the opening of the inlet guide vane of the booster is controlled. As a result, opening control of the inlet guide vane can be exercised prior to a difference actually occurring between the pressure of air on the outlet side of the booster and the set pressure. Thus, even in an unsteady state where the load on the gasifier has changed, the pressure of air supplied from the booster to the gasifier can be stabilized to ensure stable supply of air.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a configurational view showing an integrated gasification combined cycle system using an embodiment of the present invention;

FIG. 2 is a control block diagram showing an air pressure controller used in Embodiment 1 of the present invention;

FIG. 3 is a control block diagram showing an air pressure controller used in Embodiment 2 of the present invention; and

FIG. 4 is a configurational view showing a conventional integrated gasification combined cycle system.

### DETAILED DESCRIPTION OF THE INVENTION

The best mode for carrying out the present invention will now be described in detail based on embodiments of the present invention.

### Embodiment 1

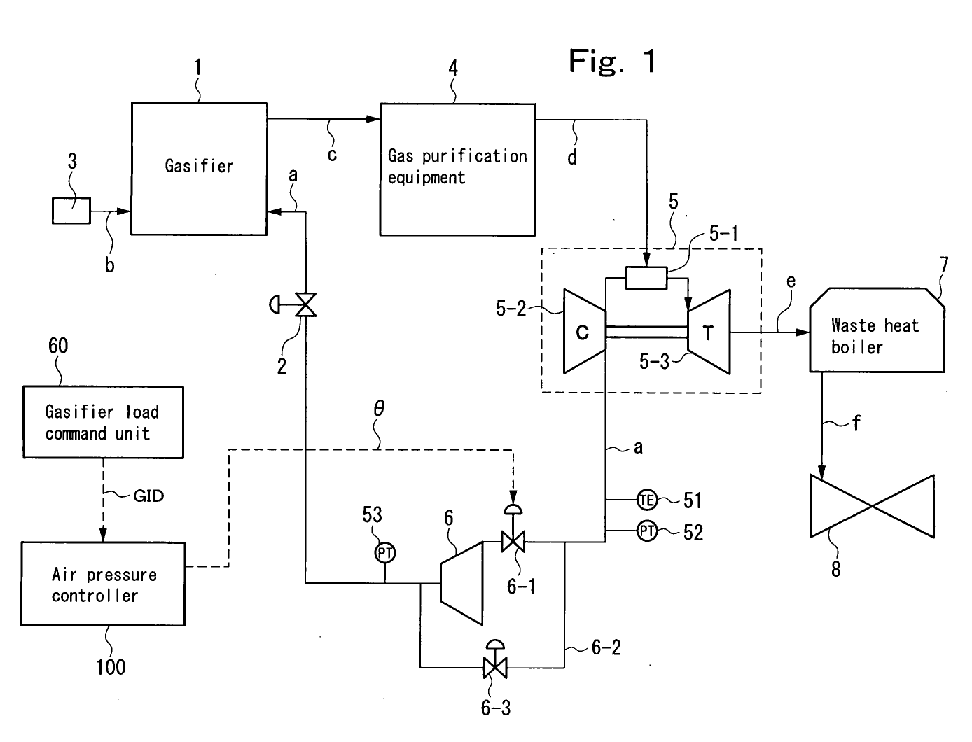

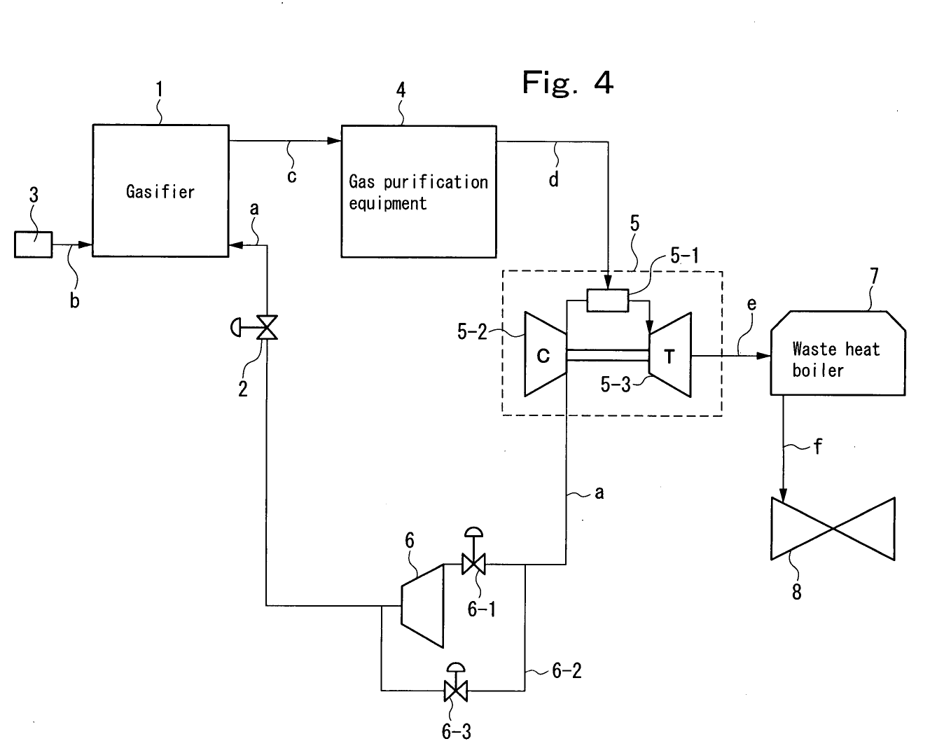

FIG. 1 shows an integrated gasification combined cycle system to which an air pressure control device according to Embodiment 1 of the present invention is applied. The system configuration of the integrated gasification combined cycle system itself is the same as that of the conventional technology shown in FIG. 4. Thus, portions which perform the same functions as those in the conventional technology are assigned the same numerals and symbols as those in the conventional technology, and duplicate explanations are omitted.

As shown in FIG. 1, an air path for supplying air a from an air compressor 5-2 to a booster 6 is provided with an inlet temperature gauge 51 and an inlet pressure gauge 52. The inlet temperature gauge 51 detects the temperature T1 of air a on the inlet side of the booster 6 (i.e., inlet temperature), and the inlet pressure gauge 52 detects the pressure P1 of air a on the inlet side of the booster 6 (i.e., inlet pressure).

An air path for supplying air a from the booster 6 to a gasifier 1 via an air supply valve 2 is provided with an outlet pressure gauge 53. The outlet pressure gauge 53 detects the pressure P2 of air a on the outlet side of the booster 6 (i.e., outlet pressure).

A gasifier load command unit 60 issues a gasifier load command GID (gasifier input demand). The value of the gasifier load command GID is a value conformed to the load on a gas turbine 5 when the gasifier 1 and the gas turbine 5 are operated in coordination. When they are not operated in coordination, this value is set by an operator.

The gasifier load command GID represents the load requirement of the gasifier 1. When the gasifier load command GID increases in value, the amount of coal b supplied to the gasifier 1 by a feeder 3 increases, and the opening of the air supply valve 2 becomes large to increase the amount of air a supplied to the gasifier 1. When the gasifier load command GID decreases in value, on the other hand, the amount of the coal b supplied to the gasifier 1 by the feeder 3 decreases, and the opening of the air supply valve 2 becomes small to decrease the amount of air a supplied to the gasifier 1. This control itself has hitherto been exercised by a control section (not shown).

When an air pressure controller 100 receives input of the gasifier load command GID, the inlet temperature T1 detected by the inlet temperature gauge 51, the inlet pressure P1 detected by the inlet pressure gauge 52, and the outlet pressure P2 detected by the outlet pressure gauge 53, the air pressure controller 100 controls the opening of the inlet guide vane 6-1 based on these data.

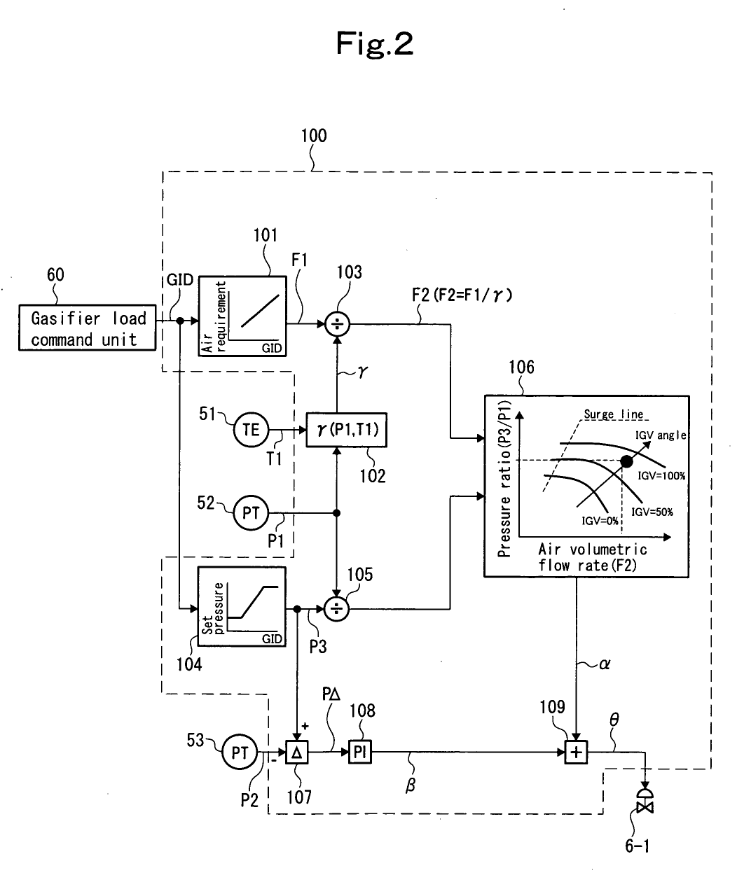

The capability constitution and control actions of the air pressure controller 100 will be described with reference to FIG. 2. A function showing the relationship between the gasifier load command GID and the air requirement (weight of air required by the gasifier 1) is preset in an air mass flow rate computing section 101 of the air pressure controller 100. This function has been determined by the characteristics of the gasifier 1. When receiving input of the gasifier load command GID, the air mass flow rate computing section 101 refers to the above function to find an air mass flow rate F1 of a value conformed to the value of the gasifier load command GID, and outputs the air mass flow rate F1. The air mass flow rate F1 is an air mass flow rate necessary to fulfill the load requirement of the gasifier 1.

An inlet air density computing section 102 substitutes the inlet temperature T1 detected y the inlet temperature gauge 51 and the inlet pressure P1 detected by the inlet pressure gauge 52 into the following equation (1) to find an inlet air density γ showing the density of air at the inlet of the booster 6, and then outputs the inlet air density γ.
γ(P1,T1)=1.29×(P1/Patm)×(⅔(273+T1))

where Patm represents a standard atmospheric pressure.

A division section 103 divides the air mass flow rate F1 by the inlet air density γ to find an air volumetric flow rate F2 (=F1/γ), and outputs the air volumetric flow rate F2.

A function showing the relationship between the gasifier load command GID and a set pressure on the outlet side of the booster 6 is preset in a set pressure computing section 104. This function has been determined by the characteristics of the gasifier 1. When receiving input of the gasifier load command GID, the set pressure computing section 104 refers to the above function to find a set pressure P3 of a value conformed to the value of the gasifier load command GID, and outputs the set pressure P3. The set pressure P3 is the pressure of air necessary to fulfill the load requirement of the gasifier 1 (i.e., set pressure).

In the present embodiment, the set pressure P3 changes according to the value of the gasifier load command GID as a result of the reference to the above function. In a case, for example, where the gasifier 1 is not operated in coordination with the gas turbine 5, however, the value of the set pressure P3 may be rendered a preset constant value.

A division section 105 divides the set pressure P3, which has been outputted by the set pressure computing section 104, by the inlet pressure P1 detected by the inlet pressure gauge 52 to find a booster pressure ratio P3/P1, and outputs the booster pressure ratio P3/P1.

A function, which adopts the air volumetric flow rate F2 and the pressure ratio P3/P1 as parameters, and determines the opening of the inlet guide vane 6-1 of the booster 6 (i.e., IGV opening) such that the values of both parameters (the value of F2 and the value of P3/P1) are satisfied, is preset in a prior opening command computing section 106. This function has been determined by the characteristics of the booster 6. When receiving input of the air volumetric flow rate F2 and the pressure ratio P3/P1, the prior opening command computing section 106 determines the IGV opening satisfying the values of both parameters (the value of F2 and the value of P3/P1), and outputs a prior opening command α showing the determined IGV opening.

As shown in FIG. 2, only the characteristics for the openings of the inlet guide vane (IGV) 6-1 of 100%, 50% and 0% are shown in the block of the prior opening command computing section 106. Actually, however, the characteristics for the IGV opening, for example, in increments or decrements of 1% have been stored and set.

A deviation computing section 107 finds deviation between the set pressure P3 and the outlet pressure P2 detected by the outlet pressure gauge 53, and outputs a deviation pressure PΔ.

A proportional plus integral computing section 108 performs the proportional plus integral computation of the deviation pressure PΔ, and outputs a feedback opening command β.

An addition section 109 adds the prior opening command α outputted by the prior opening command computing section 106 and the feedback opening command β, and outputs an opening command θ.

The inlet guide vane 6-1 has its opening adjusted to an opening indicated by the opening command θ.

Here, when the value of the gasifier load command GID changes, the prior opening command α immediately changes by a value corresponding to this change in GID.

On the other hand, when the set pressure P3 changes in accordance with the change in the value of the gasifier load command GID, the feedback opening command β changes by a value corresponding to a pressure difference between the outlet pressure P2, which is the air pressure on the outlet side of the booster 6, and the changed set pressure P3, after this pressure difference actually occurs between the outlet pressure P2 and the changed set pressure P3.

Hence, when the gasifier load command GID has changed, opening adjustment of the inlet guide vane 6-1 is made priorly by the control element of the prior opening command α of the opening command θ. As a result, even in an unsteady state where the value of the gasifier load command GID has changed, the opening of the inlet guide vane 6-1 is promptly changed to an optimum opening. Even in the unsteady state, therefore, air supply from the booster 6 to the gasifier 1 can be carried out stably.

In short, even in the unsteady state, the optimum amount of air can be supplied from the booster 6 to the gasifier 1 without excess or deficiency.

In the foregoing embodiment, the opening of the inlet guide vane 6-1 is controlled under the opening command θ comprising the prior opening command α and the feedback opening command β added together. However, opening control of the inlet guide vane 6-1 may be exercised only under the prior opening command α.

Conventionally, opening control of the inlet guide vane 6-1 has been exercised only under the feedback opening command β.

### Embodiment 2

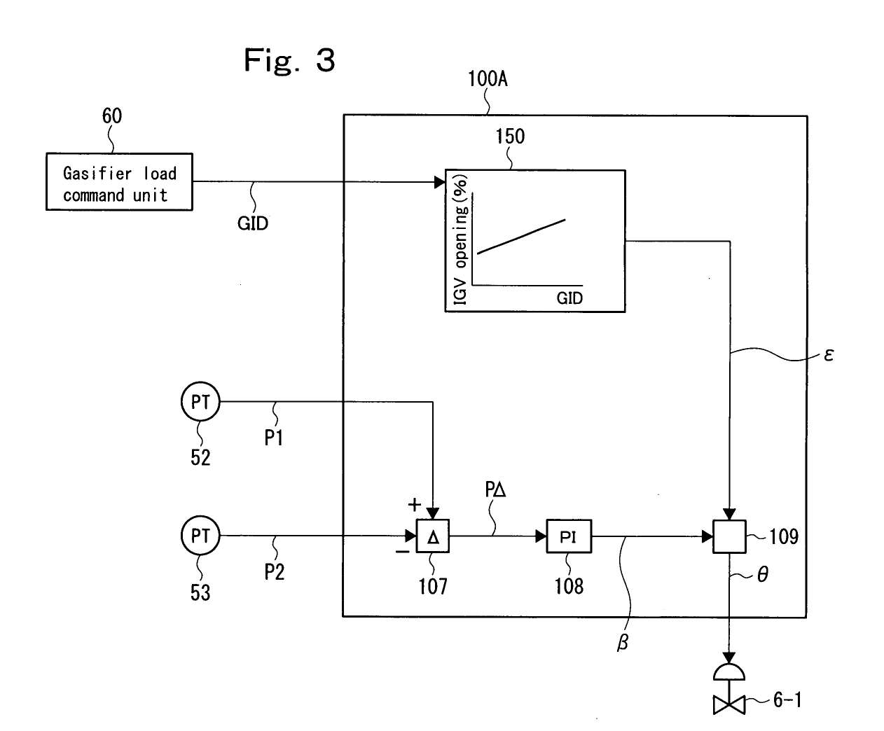

An integrated gasification combined cycle system, to which an air pressure control device according to Embodiment 2 of the present invention is applied, will be described with reference to FIG. 3.

A function showing the gasifier load command GID, and the opening of the inlet guide vane 6-1 (IGV opening) with which air necessary for operating the gasifier 1 under the gasifier load represented by the gasifier load command GID can be supplied from the booster 6 is preset in a prior opening command computing section 150 of an air pressure controller 100A of Embodiment 2. When receiving input of the gasifier load command GID, the prior opening command computing section 150 refers to the above function, and outputs the IGV opening conformed to the gasifier load command GID as a prior opening command ε.

A deviation computing section 107 finds deviation between the inlet pressure P1 detected by the inlet pressure gauge 52 and the outlet pressure P2 detected by the outlet pressure gauge 53, and outputs a deviation pressure PΔ.

A proportional plus integral computing section 108 performs the proportional plus integral computation of the deviation pressure PΔ, and outputs a feedback opening command β.

An addition section 109 adds the prior opening command ε outputted by the prior opening command computing section 150 and the feedback opening command β, and outputs an opening command θ.

The inlet guide vane 6-1 has its opening adjusted to an opening indicated by the opening command θ.

Here, when the value of the gasifier load command GID changes, the prior opening command ε immediately changes by a value corresponding to this change in GID.

On the other hand, when the inlet pressure P1 changes, the feedback opening command β changes by a value corresponding to a pressure difference between the outlet pressure P2, which is the actual air pressure on the outlet side of the booster 6, and the changed inlet pressure P1, after this pressure difference actually occurs between the outlet pressure P2 and the changed inlet pressure P1.

Hence, when the gasifier load command GID has changed, opening adjustment of the inlet guide vane 6-1 is made priorly by the control element of the prior opening command ε of the opening command θ. As a result, even in an unsteady state where the value of the gasifier load command GID has changed, the opening of the inlet guide vane 6-1 is promptly changed to an optimum opening. Even in the unsteady state, therefore, air supply from the booster 6 to the gasifier 1 can be carried out stably. In short, even in the unsteady state, the optimum amount of air can be supplied from the booster 6 to the gasifier 1 without excess or deficiency.

In the foregoing embodiment, the opening of the inlet guide vane 6-1 is controlled under the opening command θ comprising the prior opening command ε and the feedback opening command β added together. However, opening control of the inlet guide vane 6-1 may be exercised only under the prior opening command ε.

Conventionally, opening control of the inlet guide vane 6-1 has been exercised only under the feedback opening command β.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An air pressure control device in an integrated gasification combined cycle system, the integrated gasification combined cycle system including
a gasifier for forming a coal gas when supplied with coal and air,
a gas turbine driven by burning a fuel gas purified from the coal gas formed by the gasifier,
a booster for taking in air, which has been bled from an air compressor of the gas turbine, via an inlet guide vane, compresses the air taken in, and ejects the air, and
an air supply valve interposed in an air supply path for supplying the gasifier with the air ejected from the booster, the air supply valve being a valve having an opening adjusted to provide a flow rate conformed to a load requirement of the gasifier,
the air pressure control device comprising:
an inlet temperature gauge for detecting a temperature of air on an inlet side of the booster;
an inlet pressure gauge for detecting a pressure of the air on the inlet side of the booster; and
an air pressure controller for adjusting an opening of the inlet guide vane,
the air pressure controller including
air volumetric flow rate computing means for determining an air volumetric flow rate, necessary to satisfy the load requirement of the gasifier, based on a gasifier load command showing the load requirement, an inlet temperature detected by the inlet temperature gauge, and an inlet pressure detected by the inlet pressure gauge,
pressure ratio computing means for determining a set pressure of air, necessary to satisfy the load requirement, based on the gasifier load command, and determining a booster pressure ratio based on the set pressure and the inlet pressure, and
a prior opening command computing section in which a function for setting an opening of the inlet guide vane satisfying the air volumetric flow rate and the booster pressure ratio by using the air volumetric flow rate and the booster pressure ratio as parameters is preset, and which, upon receipt of input of the air volumetric flow rate and the booster pressure ratio, refers to the function, and outputs a prior opening command showing the opening of the inlet guide vane, and
the air pressure controller controlling the opening of the inlet guide vane to become the opening shown by the prior opening command.

2. An air pressure control device in an integrated gasification combined cycle system, the integrated gasification combined cycle system including
a gasifier for forming a coal gas when supplied with coal and air,
a gas turbine driven by burning a fuel gas purified from the coal gas formed by the gasifier,
a booster for taking in air, which has been bled from an air compressor of the gas turbine, via an inlet guide vane, compresses the air taken in, and ejects the air, and
an air supply valve interposed in an air supply path for supplying the gasifier with the air ejected from the booster, the air supply valve being a valve having an opening adjusted to provide a flow rate conformed to a load requirement of the gasifier,
the air pressure control device comprising:
an inlet temperature gauge for detecting a temperature of air on an inlet side of the booster;
an inlet pressure gauge for detecting a pressure of the air on the inlet side of the booster; and
an air pressure controller for adjusting an opening of the inlet guide vane,
the air pressure controller including
an air mass flow rate computing section for determining an air mass flow rate, necessary to satisfy the load requirement of the gasifier, based on a gasifier load command showing the load requirement,
an inlet air density computing section for detecting an inlet air density from an inlet temperature detected by the inlet temperature gauge, and an inlet pressure detected by the inlet pressure gauge,
a first division section for computing an air volumetric flow rate by dividing the air mass flow rate by the inlet air density,
a set pressure computing section for determining a set pressure of air, necessary to satisfy the load requirement, based on the gasifier load command,
a second division section for computing a booster pressure ratio by dividing the set pressure by the inlet pressure, and
a prior opening command computing section in which a function for setting an opening of the inlet guide vane satisfying the air volumetric flow rate and the booster pressure ratio by using the air volumetric flow rate and the booster pressure ratio as parameters is preset, and which, upon receipt of input of the air volumetric flow rate and the booster pressure ratio, refers to the function, and outputs a prior opening command showing the opening of the inlet guide vane, and
the air pressure controller controlling the opening of the inlet guide vane to become the opening shown by the prior opening command.

3. The air pressure control device in an integrated gasification combined cycle system according to claim 1, further comprising an outlet pressure gauge for detecting a pressure of the air on an outlet side of the booster,
the air pressure controller including
feedback opening command computing means for computing a feedback opening command which reduces deviation between an outlet pressure detected by the outlet pressure gauge and the set pressure to zero, and
the air pressure controller controlling the opening of the inlet guide vane to become an opening shown by a command which is a sum of the prior opening command and the feedback opening command.

4. An air pressure control device in an integrated gasification combined cycle system, the integrated gasification combined cycle system including
a gasifier for forming a coal gas when supplied with coal and air,
a gas turbine driven by burning a fuel gas purified from the coal gas formed by the gasifier,
a booster for taking in air, which has been bled from an air compressor of the gas turbine, via an inlet guide vane, compresses the air taken in, and ejects the air, and
an air supply valve interposed in an air supply path for supplying the gasifier with the air ejected from the booster, the air supply valve being a valve having an opening adjusted to provide a flow rate conformed to a load requirement of the gasifier,
the air pressure control device comprising:
an air pressure controller for adjusting an opening of the inlet guide vane,
the air pressure controller including
a prior opening command computing section in which a function showing a relation between a gasifier load command showing the load requirement of the gasifier and an opening of the inlet guide vane necessary to satisfy the load requirement is preset, and which, upon receipt of input of the gasifier load command, refers to the function, and outputs a prior opening command showing the opening of the inlet guide vane, and
the air pressure controller controlling the opening of the inlet guide vane to become the opening shown by the prior opening command.

5. The air pressure control device in an integrated gasification combined cycle system according to claim 4, further comprising
an inlet pressure gauge for detecting a pressure of the air on an inlet side of the booster, and
an outlet pressure gauge for detecting a pressure of the air on an outlet side of the booster,
the air pressure controller including
feedback opening command computing means for computing a feedback opening command which reduces deviation between an outlet pressure detected by the outlet pressure gauge and an inlet pressure detected by the inlet pressure gauge to zero, and
the air pressure controller controlling the opening of the inlet guide vane to become an opening shown by a command which is a sum of the prior opening command and the feedback opening command.

6. The air pressure control device in an integrated gasification combined cycle system according to claim 2, further comprising an outlet pressure gauge for detecting a pressure of the air on an outlet side of the booster,
the air pressure controller including
feedback opening command computing means for computing a feedback opening command which reduces deviation between an outlet pressure detected by the outlet pressure gauge and the set pressure to zero, and
the air pressure controller controlling the opening of the inlet guide vane to become an opening shown by a command which is a sum of the prior opening command and the feedback opening command.
